(19) United States
(12) Patent Application Publication
(10) Pub. No.: US 2010/0003843 A1
(43) Pub. Date: Jan. 7, 2010

(54) SMT/DIP TYPE CONNECTOR STRUCTURE HAVING AT LEAST THREE ROWS OF TERMINALS

(76) Inventor: Harry YEH, Chong-He City (TW)

Correspondence Address: Muncy, Geissler, Olds & Lowe, PLLC, P.O. BOX 1364, FAIRFAX, VA, 22038-1364, US

(21) Appl. No.: 12/358,541

(22) Filed: Jan. 23, 2009

(30) Foreign Application Priority Data
Jul. 5, 2008 (TW) 097207893

(51) Int. Cl. H01R 13/62

(52) U.S. Cl. 439/264

(57) ABSTRACT

A SMT/DIP type connector structure having at least three rows of terminals is provided. The connector structure mainly includes a printed circuit board and a connector having at least a first row of terminals, a second row of terminals and a third row of terminals. The printed circuit board is disposed centrally with respect to the connector. The first row and second row of terminals are respectively mounted to top and bottom board sides of the printed circuit board by using SMT. The third row and further rows of terminals can be mounted to the top or bottom board side of the printed circuit board selectively by using SMT or DIP. This structure can increase the speed of mounting the connector to the printed circuit board and significantly reduce the overall height of the resulted product.

### BACKGROUND OF THE INVENTION

1. Field of the Invention

The present invention relates generally to a SMT/DIP type connector structure, and more particularly, to a SMT/DIP type connector structure having at least three rows of terminals.

2. The Prior Arts

Referring to FIG. 7, mounting of a connector A on a printed circuit board (PCB) B typically involves placing the entire connector A on the PCB B and subsequently mounting a plurality of terminals A1 of the connector A to the PCB B by using dual inline package (DIP). In brief, DIP mount refers to a method of mounting a component to a circuit by inserting terminals of the component through the PCB B. Sometimes DIP mount can be performed manually.

However, as shown, the connector A is stacked on the PCB B before the subsequent DIP mount is performed, which may result in a large height H. Because a product outer casing is designed according to this height H, the dimension of the casing must be larger than this height H. This cannot meet the needs of the market which require products to be light, thin and small. Furthermore, manual insertion is labor-intensive and affects the speed of the process.

One substitute technology is the surface mount technology (SMT). According to SMT, a layer of solder paste is first applied on the PCB. After the component is placed on the PCB, the resulted assembly is heated in a reflow oven to melt the solder paste on the PCB such that the component can be tightly adhered to the PCB B. Compared with the manual insertion in DIP process, the SMT process has a higher speed and is relatively labor-saving. In addition, because the terminals are mounted to the PCB without inserting through the PCB in the SMT process, the overall height of the connector and PCB is generally smaller than the height of the DIP assembly.

However, the current SMT technology is mainly employed to mount an electronic component (e.g., the connector A) to a single-sided PCB (shown in FIG. 8), which still cannot significantly reduce the overall height of the product.

### SUMMARY OF THE INVENTION

A primary objective of the present invention is to provide a connector structure having at least three rows of terminal, which includes a connector and a printed circuit board connected to the connector by using SMT so as to increase the speed of the process and reduce the overall height of the resulted product.

Accordingly, the present invention provides a printed circuit board and a connector having at least a first row of terminals, a second row of terminals and a third row of terminals. The printed circuit board has a top board side and a bottom board side. The printed circuit board is disposed centrally with respect to the connector and between the first row of terminals and the second row of terminals. The first row of terminals and the second row of terminals are mounted to the top board side and the bottom board side of the printed circuit board by using SMT, respectively. Since the printed circuit board is disposed centrally with respect to the connector according to this embodiment of the present invention, the overall height of the product can be reduced, and the process speed can be increased by using SMT.

Since the printed circuit board is disposed centrally with respect to the connector, in addition to the first row of terminals and the second row of terminals mounted to the top board side and the bottom board side, both board sides of the printed circuit board still have room for mounting of additional rows of terminals. The present invention can be embodied in different fashions in relation to the arrangement and mounting of the third row of terminals and further rows of terminals.

If the third row of terminals is disposed below the second row of terminals, the third row of terminals extends over the second row of terminals and bends to be mounted to the bottom board side of the printed circuit board by using SMT or DIP.

If the third row of terminals is disposed above the first row of terminals, the third row of terminals extends over the first row of terminals and bends to be mounted to the top board side of the printed circuit board by using SMT or DIP.

If the connector further has a fourth row of terminals disposed below the second row of terminals, the fourth row of terminals extends over the second row of terminals and bends to be mounted to the bottom board side of the printed circuit board by using SMT.

In the present invention, the SMT is used to substitute the conventional DIP which involves purely manual insertion to mount the terminals of the connector to the printed circuit board. This can eliminate the manual insertion and a secondary process of soldering the terminals required by DIP, thereby increasing the process speed and reducing the labor cost.

In the present invention, the printed circuit board is disposed centrally with respect to the connector, and the SMT is used to mount the terminals of the connector to the printed circuit board. Both board sides of the printed circuit board have sufficient room for mounting of further rows of terminals. The overall thickness of the resulted structure is the same as the thickness of the connector, thus significantly reducing the thickness of the product.

### BRIEF DESCRIPTION OF THE DRAWINGS

FIG. 1 is a perspective view of a SMT/DIP type connector structure having at least three rows of terminals of the present invention.

FIG. 2 is a side view of a SMT/DIP type connector structure having at least three rows of terminals according to a first embodiment of the present invention.

FIG. 3 is a side view of a SMT/DIP type connector structure having at least three rows of terminals according to a second embodiment of the present invention.

FIG. 4 is a side view of a SMT/DIP type connector structure having at least three rows of terminals according to a third embodiment of the present invention.

FIG. 5 is a side view of a SMT/DIP type connector structure having at least three rows of terminals according to a fourth embodiment of the present invention.

FIG. 6 is a side view of a SMT/DIP type connector structure having at least three rows of terminals according to a fifth embodiment of the present invention.

FIG. 7 is a side view illustrating the mounting of a connector to a printed circuit board by using conventional DIP technology.

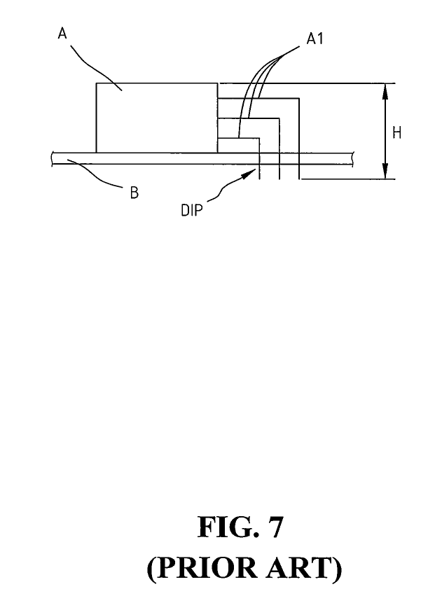

FIG. 8 is a side view illustrating the mounting of a connector to a printed circuit board by using conventional SMT technology.

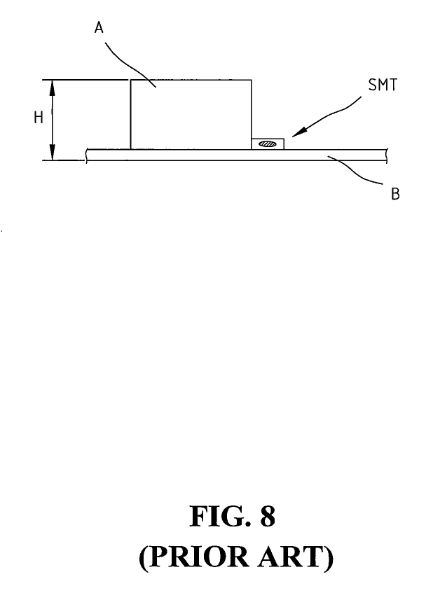

### DETAILED DESCRIPTION OF THE PREFERRED EMBODIMENTS

The present invention will be apparent to those skilled in the art by reading the following detailed description of preferred embodiments thereof, with reference to the attached drawings.

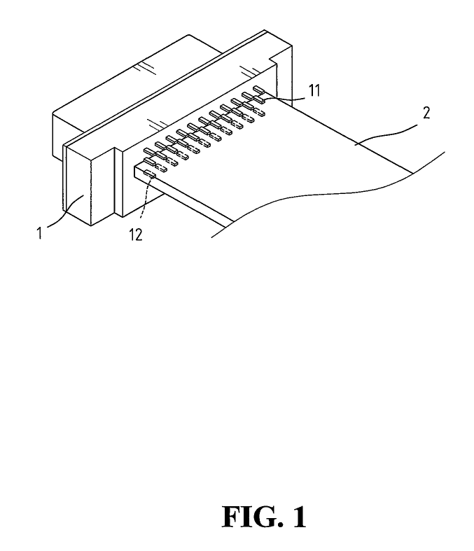

FIG. 1 is a perspective view of a SMT/DIP type connector structure of the present invention. The present invention discloses a SMT/DIP type connector structure having at least three rows of terminals, which mainly comprises a connector 1 and a printed circuit board 2 connected to the connector 1. The connector 1 of the present invention can be of any types, such as, USB, DVI, D-SUB, or the like, and is described herein as a DVI connector in the preferred embodiment for the purpose of description only. The printed circuit board 2 includes a top board side and a bottom board side, and is disposed generally centrally with respect to the connector 1, specifically between a first row of terminals 11 and a second row of terminals 12 of the connector 1. The first row of terminals 11 and the second row of terminals 12 are mounted to the top board side and the bottom board side of the printed circuit board 2 by using SMT, respectively. Several embodiments of the present invention are described below in relation to the arrangement and mounting of a third and further rows of terminals to the printed circuit board.

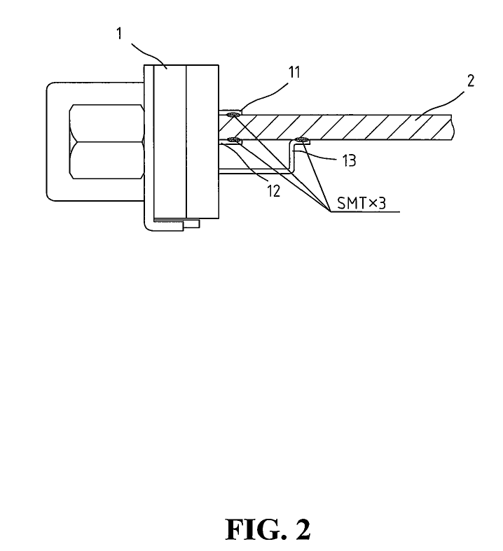

FIG. 2 is a side view of a SMT/DIP type connector structure having at least three rows of terminals in accordance with a first embodiment of the present invention. Since the printed circuit board 2 is disposed generally centrally with respect to the connector 1, after the first row of terminals 11 and the second row of terminals 12 are mounted on the top board side and the bottom board side, both board sides of the printed circuit board 2 still have room for mounting of additional terminals. If the third row of terminals 13 is disposed below the second row of terminals 12, the third row of terminals 13 extends over the second row of terminals 12 and bends to be mounted to the bottom board side of the printed circuit board 2 by using SMT.

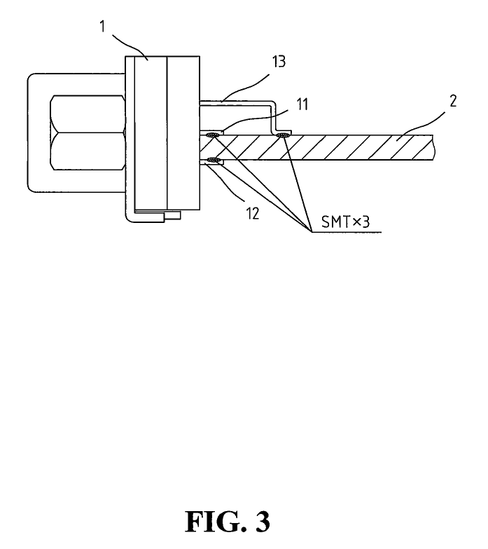

FIG. 3 is a side view of a SMT/DIP type connector structure having at least three terminals in accordance with a second embodiment of the present invention. If the third row of terminals 13 is disposed above the first row of terminals 11, the third row of terminals 13 extends over the first row of terminals 11 and bends to be mounted to the top board side of the printed circuit board 2 by using SMT.

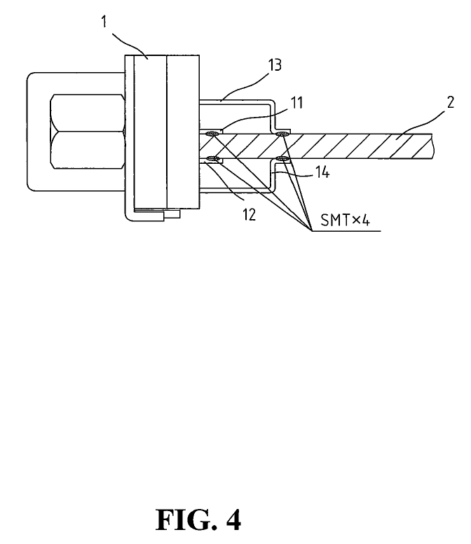

FIG. 4 is a side view of a SMT/DIP type connector structure having at least three terminals in accordance with a third embodiment of the present invention. If the connector 1 further includes a fourth row of terminals 14 disposed below the second row of terminals 12, the fourth row of terminals 14 extends over the second row of terminals 12 and bends to be mounted to the bottom board side of the printed circuit board 2 by using SMT.

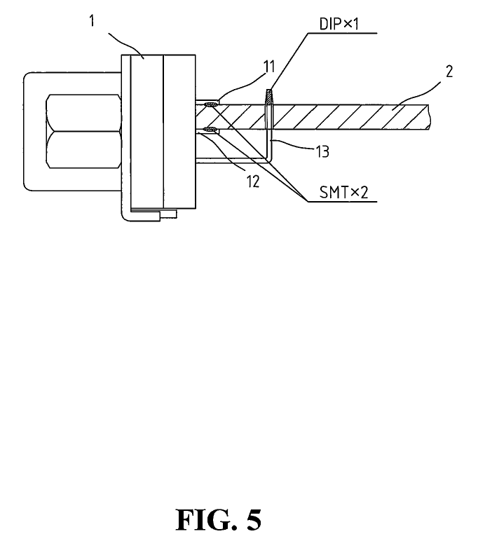

FIG. 5 is a side view of a SMT/DIP type connector structure having at least three terminals in accordance with a fourth embodiment of the present invention. In this illustrated embodiment, after the first row of terminals 11 and the second row of terminals 12 are mounted on the top board side and the bottom board side the printed circuit board 2 by using SMT, both board sides of the printed circuit board 2 still remain room for mounting of a third row of terminals 13 by using dual inline package (DIP). If the third row of terminals 13 is disposed below the second row of terminals 12, the third row of terminals 13 extends over the second row of terminals 12 and bends to be mounted to the bottom board side of the printed circuit board 2 by using DIP.

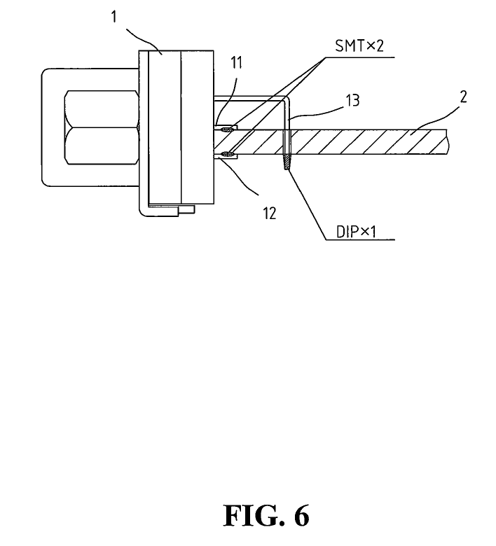

FIG. 6 is a side view of a SMT/DIP type connector structure having at least three terminals in accordance with a fifth embodiment of the present invention. If the third row of terminals 13 is disposed above the first row of terminals 11, the third row of terminals 13 extends over the first row of terminals 11 and bends to be mounted to the top board side of the printed circuit board 2 by using DIP

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A SMT/DIP type connector structure having at least three rows of terminals, comprising:
a printed circuit board having a top board side and a bottom board side; and
a connector having at least a first row of terminals, a second row of terminals and a third row of terminals, the printed circuit board being disposed centrally with respect to the connector and between the first row of terminals and the second row of terminals, the first row of terminals and the second row of terminals being respectively mounted to the top board side and the bottom board side of the printed circuit board by using surface mount technology (SMT), the third row of terminals being mounted to the printed circuit board.

2. The SMT/DIP type connector structure as claimed in claim 1, wherein the third row of terminals extends over the second row of terminals and is mounted to the bottom board side of the printed circuit board by using SMT.

3. The SMT/DIP type connector structure as claimed in claim 1, wherein the third row of terminals extends over the first row of terminals and is mounted to the top board side of the printed circuit board by using SMT.

4. The SMT/DIP type connector structure as claimed in claim 1, wherein the third row of terminals extends over the first row of terminals and is mounted to the top board side of the printed circuit board by using SMT, and the connector further comprises a fourth row of terminals extending over the second row of terminals and mounted to the bottom board side of the printed circuit board by using SMT.

5. The SMT/DIP type connector structure as claimed in claim 1, wherein the third row of terminals extends over the second row of terminals and is mounted to the bottom board side of the printed circuit board by using dual inline package (DIP).

6. The SMT/DIP type connector structure as claimed in claim 1, wherein the third row of terminals extends over the first row of terminals and is mounted to the top board side of the printed circuit board by using dual inline package (DIP).
